(19) United States
(12) Patent Application Publication
(10) Pub. No.: US 2024/0427499 A1
(43) Pub. Date: Dec. 26, 2024

(54) TRANSMISSION DEVICE AND TRANSMISSION SYSTEM

(71) Applicant: Fujitsu Limited, Kawasaki-shi (JP)

(72) Inventors: Ichiro YOKOKURA, Sano (JP); Junichi SUGIYAMA, Kawasaki (JP); Yusuke TANABE, Sendai (JP)

(73) Assignee: Fujitsu Limited, Kawasaki-shi (JP)

(21) Appl. No.: 18/650,171

(22) Filed: Apr. 30, 2024

(30) Foreign Application Priority Data
Jun. 22, 2023 (JP) 2023-102704

(51) Int. Cl. G06F 3/06

(52) U.S. Cl. CPC G06F 3/0619; G06F 3/0652; G06F 3/0688

(57) ABSTRACT

A transmission device transmits signals between a server and an opposing device. The transmission device includes a memory and includes a controller that controls a first queue and a second queue in the server and controls the memory. When detecting issuance of a processing request from the server to the opposing device, the controller queues the processing request in the first queue, obtains the data from the server according to the processing request, and stores the obtained data in the memory. After requesting the transfer of the data and the processing request to the opposing device, before executing the processing request in the opposing device, the controller queues the processing completion of the processing in the second queue and releases the queue of the processing completion.

### CROSS-REFERENCE TO RELATED APPLICATION

This application is based upon and claims the benefit of priority of the prior Japanese Patent Application No. 2023-102704, filed on Jun. 22, 2023, the entire contents of which are incorporated herein by reference.

### FIELD

The embodiment discussed herein is related to a transmission device and a transmission system.

### BACKGROUND

At present, for example, as far as the data communication within a data center is concerned, it is known that the NVMe (Non-Volatile Memory express) is used when the CPU (Central Processing Unit) of a computing server gains a high-speed access to a broadband SSD (Solid State Drive) storage.

Moreover, with the aim of achieving high speed and high efficiency in the data communication between a computing server and a storage server, the NVMe-of (over fabric) is known as the expanded version of the NVMe. For example, by performing encapsulation using Ethernet (registered trademark) or the Infini-band protocol, the NVMe-of enables surpassing fabrics such as the L2SW. In the data communication based on the NVMe-of, for example, the NVMe-over RDMA is known in which the RDMA (Remote Direct Memory Access) protocol is used. Moreover, as far as the NVMe-of processing is concerned, in order to reduce the network control load on the host CPU of the computing server, it is known that the network control load is offloaded to a smart NIC (Network Interface Card).

In a transmission system in which the NVMe-of is implemented, queue-based management/control is performed between the host CPU of a computing server and the NVMe controller of a storage server. As a result, the arbitration is performed regarding the differences in the performance of various processing units, and the ordering and reachability is guaranteed. The host CPU includes an admin used for controlling the NVMe controller, and includes an I/O used for data transfer. The admin and the I/O have one or more SQs (Submission Queues)/CQs (Completion Queues) assigned thereto. An SQ is a circular buffer in which the processing requests issued by the host CPU to the NVMe controller are queued. A CO is a circular buffer in which processing-completion flags of the already-executed processing requests are queued. The NVMe too includes an admin and an I/that have one or more SQs/CQs assigned thereto.
Patent Literature 1: U.S. Patent Application Publication No. 2022/0197710
Patent Literature 2: Japanese Laid-open Patent Publication No. 2022-122478
Patent Literature 3: U.S. Patent Application Publication No. 2020/0177660
Patent Literature 4: International Publication Pamphlet No. WO 2016/135875

In a transmission system in which the NVMe-of is implemented, the distance between a computing server and a storage server is, for example, only a short distance of about 1 km. However, in the transmission system of a data center, while there is a demand to achieve low delay and low power consumption, the practical implementation of optical transmission and CPO (Co-Packaged Optics) is also being studied. Accordingly, in future, long-distance transmission among data centers using L1 frames for optical transmission is also believed to become a demand. In that regard, it is a fact that there is a demand for a long-distance NVMe-of transmission system having the distance between the computing server and the storage server to be equal to, for example, about 1200 km.

### SUMMARY

According to an aspect of an embodiment, a transmission device transmits a signal between a server and an opposing device. The transmission device includes a memory and a controller that controls a first queue in the server and a second queue in the server, and controls the memory. When detecting issuance of a processing request from the server to the opposing device, the controller queues the processing request in the first queue, obtains data from the server according to the processing request, and stores the obtained data in the memory. After requesting transfer of the data and the processing request to the opposing device and before executing the processing request in the opposing device, the controller queues processing completion of the processing request in the second queue and releases queue of the processing completion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of an optical transmission system according to a working example;

FIG. 2 is a block diagram illustrating an example of a first smart NIC and a second smart NIC used in the optical transmission system according to the present working example;

FIGS. 3A, 3B and 4 are sequence diagrams illustrating an example of the operations performed in the optical transmission system in regard to write-request processing;

FIGS. 5A, 5B and 6 are sequence diagrams illustrating an example of the operations performed in the optical transmission system in regard to a first-type data retransmission operation;

FIGS. 7A, 7B, 8A and 8B are sequence diagrams illustrating an example of the operations performed in the optical transmission system in regard to a second-type data retransmission operation;

FIG. 9 is an explanatory diagram for explaining an example of the comparison result of comparison between the optical transmission system according to the present working example and an optical transmission system according to a comparison example;

FIG. 10 is an explanatory diagram illustrating an example of the optical transmission system according to the comparison example;

FIG. 11 is an explanatory diagram illustrating an example of a third smart NIC and a fourth smart NIC used in the optical transmission system according to the comparison example;

FIGS. 12A, 12B, 13A and 13B are sequence diagrams illustrating an example of the operations performed in the optical transmission system according to the comparison example in regard to write-request processing; and

FIG. 14 is an explanatory diagram illustrating an example of the comparison result between a conventional short-distance transmission system and the optical transmission system according to the comparison example.

### DESCRIPTION OF EMBODIMENT

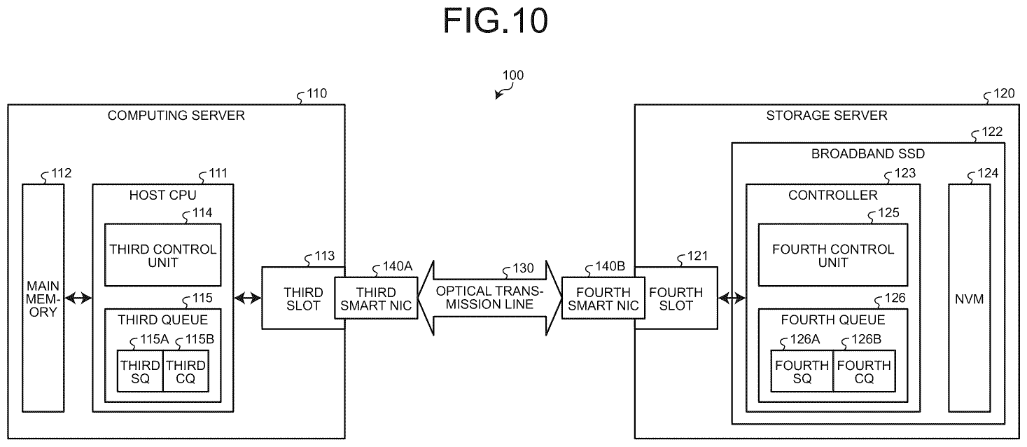

Given below is the explanation of an optical transmission system 100 that implements long-distance transmission between data centers according to a comparison example. FIG. 10 is an explanatory diagram illustrating an example of the optical transmission system 100 according to the comparison example. The optical transmission system 100 illustrated in FIG. 10 includes a computing server 110, a storage server 120, and an optical transmission line 130 that establishes a communication connection between the computing server 110 and the storage server 120. The computing server 110 is a server that includes a host CPU (Central Processing Unit) 111, a main memory 112, and a third slot 113.

The host CPU 111 controls the computing server 110 in entirety. The host CPU 111 includes a third control unit 114 that controls the main memory 112, and a third queue 115 that is used in the NVMe-of protocol. The third queue 115 includes a third SQ (Submission Queue) 115A and a third CQ (Completion Queue) 115B. The third SQ 115A is a circular buffer present in the computing server 110 in which the processing requests of the NVMe-of protocol, which are issued by the host CPU 111 to a controller 123, are queued. The third CQ 115B is a circular buffer present in the computing server 110 in which processing-completion flags, which indicate the completion of processing of the processing requests, are queued.

The main memory 112 is, for example, a DDR (Double Data Rate) memory used to store the data. The optical transmission line 130 is, for example, a WDM (Wavelength Division Multiplexing) optical transmission line of an OTN (Optical Transport Network) and establishes a communication connection between the computing server 110 and the storage server 120. The third slot 113 is, for example, a slot of the PCIe (Peripheral Component Interconnect express) type and is connected to a third smart NIC (Network Interface Card) 140. Herein, the third smart NIC 140 is an NIC for enabling NVMe-of protocol communication in L1 frames for optical transmission.

The storage server 120 represents the opposing device that includes a fourth slot 121 and a broadband SSD (Solid State Drive) 122. The broadband SSD 122 controls the storage server 120 in entirety. The broadband SSD 122 includes a controller 123 and an NVM (Non-Volatile Memory) 124. The controller 123 controls the broadband SSD 122 in entirety. The controller 123 includes a fourth control unit 125 that controls the NVM 124, and a fourth queue 126 used in the NVMe-of protocol. The fourth queue 126 includes a fourth SQ 126A and a fourth CQ 126B. The fourth SQ 126A is, for example, a circular buffer present in the storage server 120 in which the processing requests of the NVMe-of protocol, which are transferred from the host CPU 111, are queued. The fourth CQ 126B is a circular buffer present in the storage server 120 in which processing-completion flags, which indicate the completion of processing of the processing requests, are queued. The NVM 124 is a nonvolatile auxiliary storage device used to store the data.

The fourth slot 121 is a slot of the PCIe type and is connected to the fourth smart NIC 140B. The fourth smart NIC 140B is an NIC for enabling NVMe-of protocol communication in L1 frames for optical transmission.

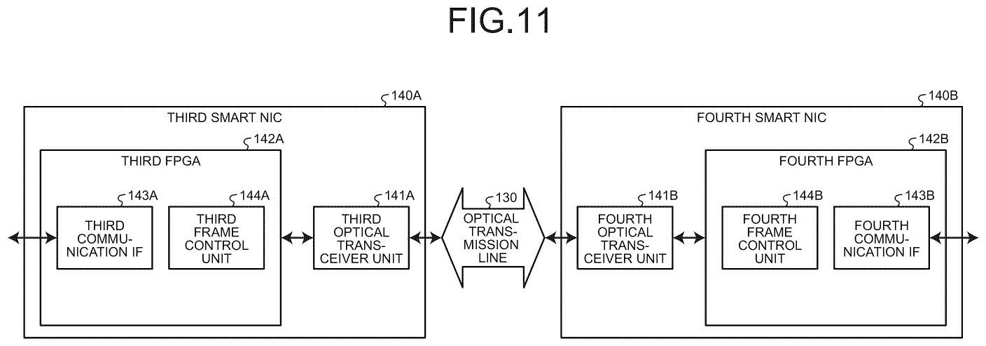

FIG. 11 is an explanatory diagram illustrating an example of the third smart NIC 140A and the fourth smart NIC 140B used in the optical transmission system 100 according to the comparison example. The third smart NIC 140A includes a third optical transceiver unit 141A and a third FPGA (Field Programmable Gate Array) 142A. The third optical transceiver unit 141A is an optical transceiver that performs optical transmission with the optical transmission line 130 and that is equipped with the photoelectric conversion function. The third FPGA 142A includes a third communication IF 143A and a third frame control unit 144A. The third communication IF 143A is a communication IF for performing communication with the third slot 113. The third frame control unit 144A is a signal processing unit that, at the time of communicating with the optical transmission line 130, performs encapsulation (assembly) or decapsulation (decomposition) of signals into L1 frames for optical transmission.

The fourth smart NIC 140B includes a fourth optical transceiver unit 141B and a fourth FPGA 142B. The fourth optical transceiver unit 141B is an optical transceiver that performs optical transmission with the optical transmission line 130 and that is equipped with the photoelectric conversion function. The fourth FPGA 142B includes a fourth communication IF 143B and a fourth frame control unit 144B. The fourth communication IF 143B is a communication IF for performing communication with the fourth slot 121. The fourth frame control unit 144B is a signal processing unit that, at the time of communicating with the optical transmission line 130, performs encapsulation (assembly) or decapsulation (decomposition) of signals into L1 frames for optical transmission.

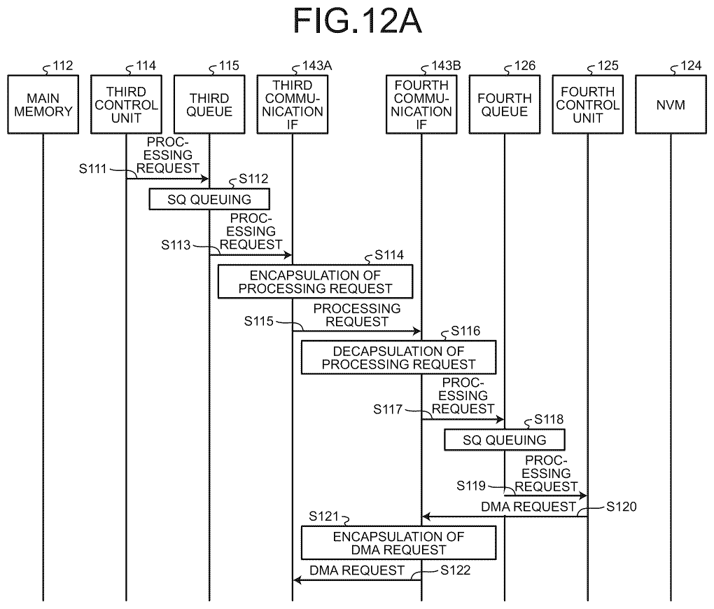

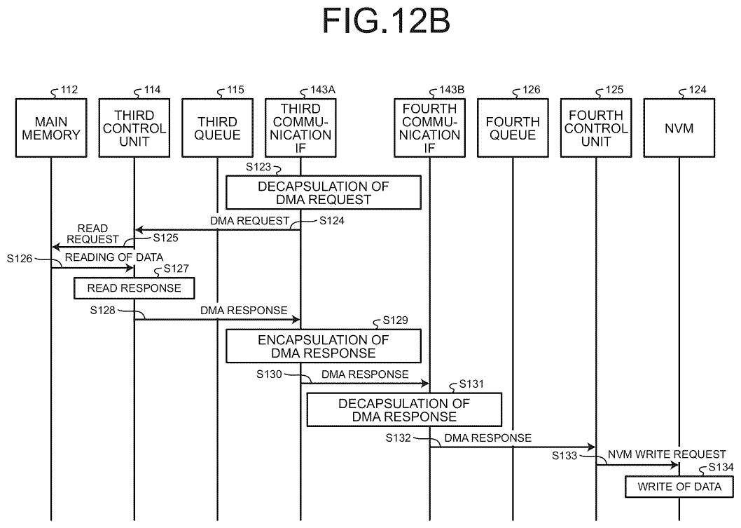

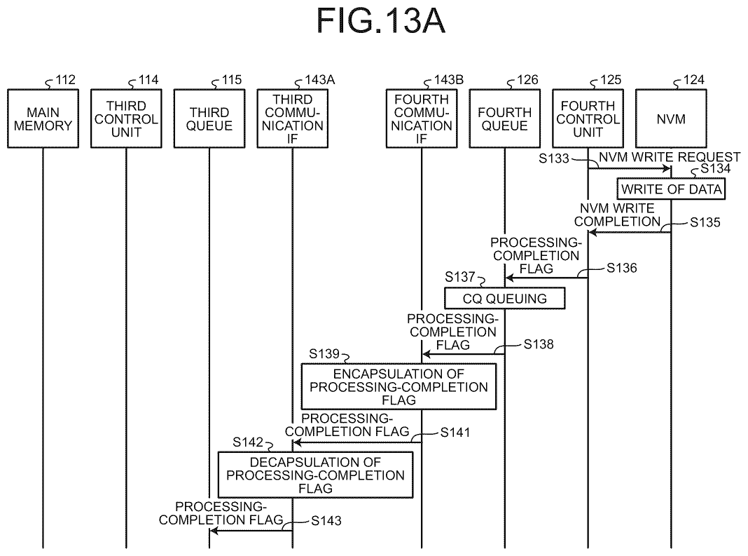

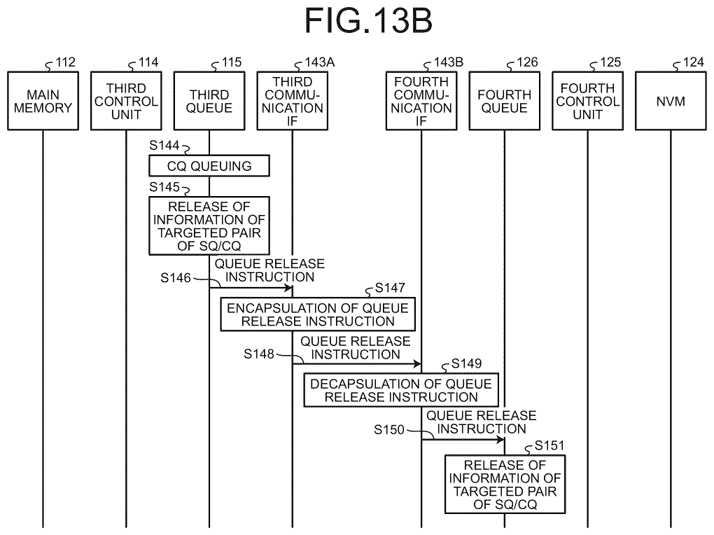

FIGS. 12A, 12B, 13A and 13B are sequence diagrams illustrating an example of the operations performed in the optical transmission system 100 according to the comparison example in regard to write-request processing. In the host CPU 111, the third control unit 114 issues an NVMe protocol processing request such as a processing request for writing the target data for writing, which is stored in the main memory 112, into the NVM 124, and notifies the third queue 115 about the issued processing request (Step S111). Then, in the third queue 115, the notified processing request is subjected to SQ queuing in the third SQ 115A (Step S112).

In the third smart NIC 140A, the third frame control unit 144A detects a processing request, which is being queued in the third SQ 115A, according to the doorbell function of the third queue 115 (Step S113), and encapsulates the detected processing request (Step S114). The third frame control unit 144A performs optical conversion of the encapsulated processing request using the third optical transceiver unit 141A, and optically transmits the post-optical-conversion processing request to the fourth smart NIC 140B of the storage server 120 via the optical transmission line 130 (Step S115).

In the fourth smart NIC 140, the fourth frame control unit 144B performs photoelectric conversion of the encapsulated processing request using the fourth optical transceiver unit 141B, and decapsulates the post-photoelectric-conversion processing request (Step S116). Then, the fourth frame control unit 144B notifies the fourth queue 126 of the controller 123 about the decapsulated processing request (Step S117). In the fourth queue 126, the notified processing request is subjected to SQ queuing in the fourth SQ 126A (Step S118).

In the controller 123, the fourth control unit 125 detects the processing request, which is being queued in the fourth SQ 126A, according to the doorbell function of the fourth queue 126 (Step S119). Then, according to the detected processing request, the fourth control unit 125 issues a DMA (Direct Memory Access) request to the fourth frame control unit 144B (Step S120). Then, the fourth frame control unit 144B encapsulates the DMA request (Step S121). Moreover, the fourth frame control unit 144B performs optical conversion of the DMA request using the fourth optical transceiver unit 141B, and optically transmits the post-optical-conversion encapsulated DMA request to the third smart NIC 140A via the optical transmission line 130 (Step S122).

In the third smart NIC 140A, the third frame control unit 144A performs electrical conversion of the encapsulated DMA request and decapsulates the post-electrical-conversion DMA request (Step S123). More particularly, the third frame control unit 144A sends the decapsulated DMA request to the third control unit 114 of the host CPU 111 (Step S124). According to the DMA request, the third control unit 114 issues a read request to the main memory 112 (Step S125). According to the read request, the main memory 112 reads the target data for writing (Step S126) and sends a read response, which includes the target data for writing that has been read, to the third control unit 114 (Step S127).

When detecting the read response, the third control unit 114 sends a DMA response, which includes the target data for writing that has been read, to the third frame control unit 144A (Step S128). Then, the third frame control unit 144A encapsulates the DMA response (Step S129). Moreover, the third frame control unit 144A performs optical conversion of the encapsulated DMA response using the third optical transceiver unit 141A, and optically transmits the post-optical-conversion DMA response to the fourth smart NIC 140B via the optical transmission line 130 (Step S130).

In the fourth smart NIC 140B, the fourth frame control unit 144B performs electrical conversion of the encapsulated DMA response using the fourth optical transceiver unit 141B, and decapsulates the post-electrical-conversion DMA response (Step S131). Then, the fourth frame control unit 144B sends the decapsulated DMA response to the fourth control unit 125 (Step S132). According to the DMA response, the fourth control unit 125 issues an NVM write request to the NVM 124 for writing the target data for writing, which is specified in the DMA response, in the NVM 124 (Step S133).

According to the NVM write request, the target data for writing is written in the NVM 124 (Step S134), and the fourth control unit 125 is notified about NVM write completion indicating the completion of the writing (Step S135). When detecting NVM write completion, the fourth control unit 125 sends a processing-completion flag, which indicates the completion of processing of the processing request, to the fourth queue 126 (Step S136). In the fourth queue 126, The processing-completion flag is subjected to CQ queuing in the fourth CQ 126B (Step S137). The fourth frame control unit 144B detects the processing-completion flag in the fourth CQ 126B according to the doorbell function of the fourth queue 126 (Step S138). Then, the fourth frame control unit 144B encapsulates the processing-completion flag (Step S139). Moreover, the fourth frame control unit 144B performs optical conversion of the encapsulated processing using the fourth optical transceiver unit 141B, and optically transmits the post-optical-conversion processing-completion flag to the third smart NIC 140A via the optical transmission line 130 (Step S141).

In the third smart NIC 140A, the third frame control unit 144A performs electrical conversion of the encapsulated processing-completion flag and decapsulates the post-electrical-conversion processing-completion flag (Step S142). Moreover, the third frame control unit 144A notifies the third queue 115 of the host CPU 111 about the decapsulated processing-completion flag (Step S143).

In the third queue 115, the notified processing-completion flag is subjected to CQ queuing in the third CQ 115B (Step S144). Then, the information about the targeted pair of SQ/CQ is released from the third queue 115 (Step S145), and a queue release instruction is issued to the third frame control unit 144A for releasing the queue of the fourth queue 126 (Step S146). The third frame control unit 144A encapsulates the queue release instruction (Step S147). Moreover, the third frame control unit 144A performs optical conversion of the encapsulated queue release instruction using the third optical transceiver unit 141A, and optically transmits the post-optical-conversion queue release instruction to the fourth smart NIC 140B via the optical transmission line 130 (Step S148).

In the fourth smart NIC 140B, the fourth frame control unit 144B performs electrical conversion of the encapsulated queue release instruction using the fourth optical transceiver unit 141B, and decapsulates the post-electrical-conversion queue release instruction (Step S149). Moreover, the fourth frame control unit 144B sends the decapsulated queue release instruction to the fourth CQ 126B of the controller 123 (Step S150). Then, the information about the targeted pair of SQ/CQ is released from the fourth queue 126 (Step S151). That marks the end of the operations explained with reference to FIGS. 13A and 13B.

In the write-request processing, transmission delay occurs due a total of five handshakes occurring at the following operations: the issuance of a processing request at Step S115, the issuance of a DMA request at Step S122, the transmission of a DMA response at Step S130, the transmission of a processing-completion flag at Step S141, and the transmission of a queue release instruction at Step S148. That is, if “t” represents a single instance of transmission delay attributed to a handshake occurring between a computing server 2 and a storage server 3, then “5t” indicates the transmission delay attributed to the handshakes occurring from the issuance of a single processing request to the completion of execution of that processing request.

Thus, in the optical transmission system 100 according to the comparison example, when long-distance optical transmission is performed, there occurs the transmission delay 5t equivalent to the handshake count between the computing server 110 and the storage server 120. That transmission delay is included in the processing time and also becomes the dominant term, it results in queue congestion on a permanent basis thereby causing a significant decline in the throughput. In order to improve on the queue congestion, it is possible to think of installing a large number of CPU cores in the host CPU 111 and the controller 123 and sharing the processing load. However, that leads to an increase in the component cost.

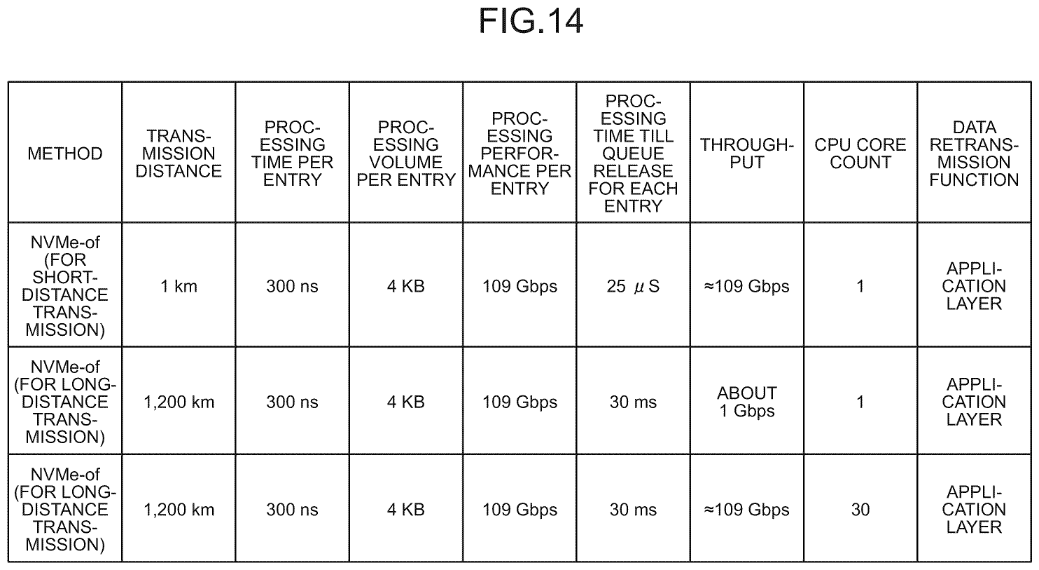

Given below is the explanation of the comparison result between the throughput of a short-distance transmission system of the NVMe-of type implemented for short-distance optical transmission and the throughput of a long-distance transmission system of the NVMe-of type implemented for long-distance optical transmission. FIG. 14 is an explanatory diagram illustrating an example of the comparison result between a conventional short-distance transmission system and the optical transmission system according to the comparison example. In a short-distance transmission system of the NVMe-of type implemented for short-distance optical transmission, the transmission distance between the computing server and the storage server is set to 1 km, the processing time per entry of a processing request is set to 300 ns, and the processing volume per entry is set to 4 KB. Moreover, in the short-distance transmission system, the processing performance per entry is set to 109 Gbps, the processing time till the queue release for each entry is set to 25 μs, and the core count of the CPU is set to one. In that case, the short-distance transmission system has the throughput of about 109 Gbps.

In the optical transmission system 100 of the NVMe-of type according to the comparison example in which a single-core CPU is used for long-distance optical transmission, the transmission distance between the computing server 110 and the storage server 120 is set to 1200 km, and the processing time per entry is set to 300 ns. Moreover, in the optical transmission system 100, the processing volume per entry is set to 4 KB, the processing performance per entry is set to 109 Gbps, the processing time till the queue release for each entry is set to 30 μs, and the core count of the CPU is set to one. In that case, the optical transmission system 100 according to the comparison example has the throughput of about 1 Gbps. Thus, it can be understood that, in the optical transmission system 100 according to the comparison example, due to the occurrence of a transmission delay, the throughput undergoes a significant decline as compared to the short-distance transmission system.

In contrast, in an optical transmission system of the NVMe-of type in which a multicore CPU is used for long-distance transmission, the transmission distance between the computing server 110 and the storage server 120 is set to 1200 km, and the processing time per entry is set to 300 ns. Moreover, in the optical transmission system, the processing volume per entry is set to 4 KB, the processing performance per entry is set to 109 Gbps, the processing time till the queue release for each entry is set to 30 μs, and the core count of the CPU is set to 30. In that case, since the processors share the processing load, the optical transmission system has the throughput of about 109 Gbps.

Thus, in the optical transmission system 100 of the NVMe-of type according to the comparison example in which a single-core CPU is used for long-distance optical transmission, it can be understood that, when long-distance transmission is performed, there occurs a transmission delay equivalent to the handshake count and there is a significant decline in the throughput. In that regard, as a result of increasing the core count of the CPU, it is possible to improve the throughput. However, it also leads to a significant increase in the component cost. Hence, there is a demand for an optical transmission system of the NVMe-of type that is suitable for long-distance transmission and that enables achieving improvement in the throughput without having to increase the core count of the CPU. In that regard, an embodiment of such an optical transmission system is described below as a working example. Meanwhile, the technology disclosed herein is not limited by the working example described below. Moreover, embodiments can be appropriately combined without causing any contradictions.

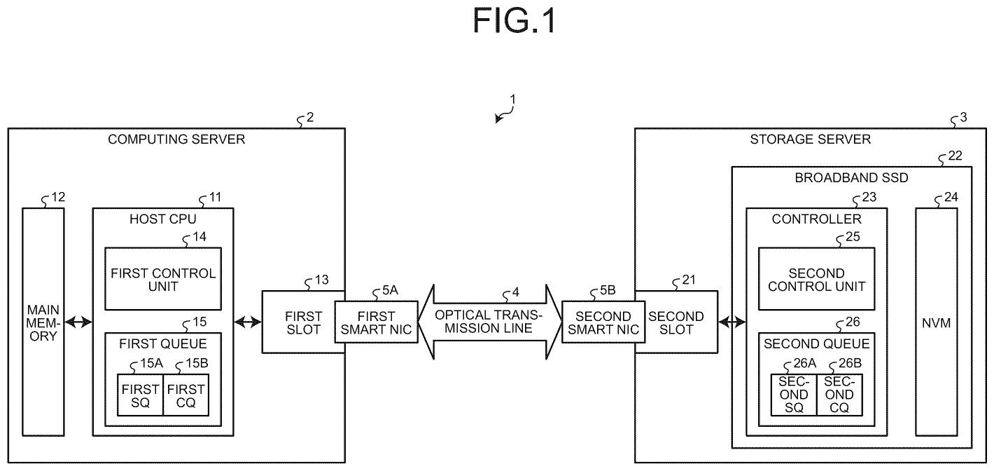

FIG. 1 is an explanatory diagram illustrating an example of an optical transmission system 1 according to the present working example. The optical transmission system 1 illustrated in FIG. 1 includes a computing server 2, a storage server 3, and an optical transmission line 4 that establishes a communication connection between the computing server 2 and the storage server 3. The computing server 2 is a server that includes a host CPU (Central Processing Unit) 11, a main memory 12, and a first slot 13. The host CPU 11 controls the computing server 2 in entirety. The host CPU 11 includes a first control unit 14 that controls the main memory 12, and a first queue 15 that is used in the NVMe-of protocol. The first queue 15 includes a first SQ (Submission Queue) 15A and a first CQ (Completion Queue) 15B. The first SQ 15A is, for example, a circular buffer present in the computing server 2 in which the processing requests of the NVMe protocol, which are issued by the host CPU 11 to a controller 23, are queued. The first CQ 15B is a circular buffer present in the computing server 2 in which processing-completion flags, which indicates the completion of processing of the processing requests, are queued.

The main memory 12 is, for example, a DDR (Double Data Rate) memory used to store the data. The optical transmission line 4 is, for example, a WDM (Wavelength Division Multiplexing) optical transmission line of an OTN (Optical Transport Network) and establishes a communication connection between the computing server 2 and the storage server 3. The first slot 13 is, for example, a slot of the PCIe (Peripheral Component Interconnect express) type and is connected to a first smart NIC (Network Interface Card) 5A. The first smart NIC 5A is an NIC for enabling NVMe-of protocol communication in L1 frames for optical transmission. The first smart NIC 5A is connected to the first slot 13 in a detachably-attachable manner.

The storage server 3 represents the opposing device that includes a second slot 21 and a broadband SSD (Solid State Drive) 22. The broadband SSD 22 controls the storage server 3 in entirety. The broadband SSD 22 includes a controller 23 and an NVM (Non-Volatile Memory) 24. The controller 23 controls the broadband SSD 22 in entirety. The controller 23 includes a second control unit 25 that controls the NVM 24, and a second queue 26 that is used in the NVMe-of protocol. The second queue 26 includes a second SQ 26A and a second CQ 26B. The second SQ 26A is a circular buffer present in the storage server 3 in which the processing requests of the NVMe-of protocol, which are transferred from the host CPU 11, are queued. The second CQ 26B is a circular buffer present in the storage server 3 in which processing-completion flags, which indicates the completion of processing of the processing requests, are queued. The NVM 24 is a nonvolatile auxiliary storage device used to store the data.

The second slot 21 is, for example, a slot of the PCIe (Peripheral Component Interconnect express) type and is connected to a second smart NIC 5B. The second smart NIC 5B is an NIC for enabling NVMe-of protocol communication in L1 frames for optical transmission. The second smart NIC 5B is connected to the second slot 21 in a detachably-attachable manner.

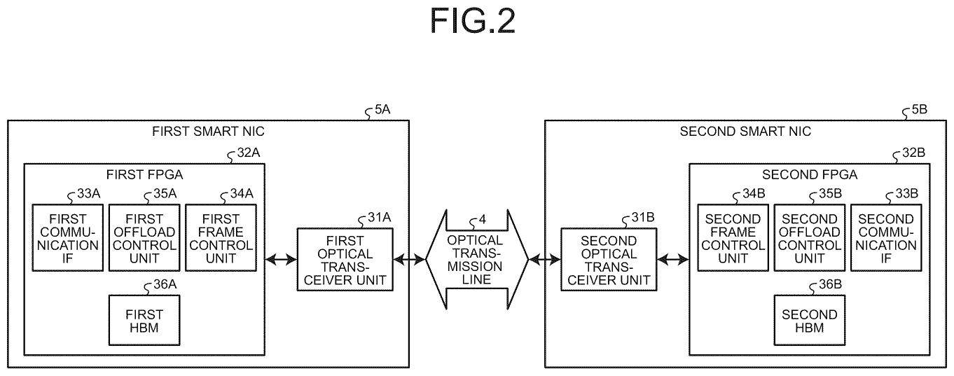

FIG. 2 is a block diagram illustrating an example of the first smart NIC 5A and the second smart NIC 5B used in the optical transmission system 1 according to the present working example. The first smart NIC 5A includes a first optical transceiver unit 31A and a first FPGA (Field Programmable Gate Array) 32A. The first optical transceiver unit 31A is an optical transceiver that performs optical transmission with the optical transmission line 4 and that is equipped with the photoelectric conversion function. The first FPGA 32A includes a first communication IF 33A, a first frame control unit 34A, a first offload control unit 35A, and a first HBM (High Bandwidth Memory) 36A. The first communication IF 33A is a communication IF for communicating with the first slot 13. The first frame control unit 34A is a signal processing unit that, at the time of communicating with the optical transmission line 4, performs encapsulation (assembly) or decapsulation (decomposition) of signals into L1 frames for optical transmission. The first offload control unit 35A performs the processing related to NVMe-of and enables achieving reduction in the processing load of the first control unit 14. The first HBM 36A is a large-capacity memory device used to store the data.

The second smart NIC 5B includes a second optical transceiver unit 31B and a second FPGA 32B. The second optical transceiver unit 31B is an optical transceiver that performs optical transmission with the optical transmission line 4 and that is equipped with the photoelectric conversion function. The second FPGA 32B includes a second communication IF 33B, a second frame control unit 34B, a second offload control unit 35B, and a second HBM 36B. The second communication IF 33B is a communication IF for performing communication with the second slot 21. The second frame control unit 34B is a signal processing unit that, at the time of communicating with the optical transmission line 4, performs encapsulation or decapsulation of signals into L1 frames for optical transmission. The second offload control unit 35B performs the processing related to NVMe-of and enables achieving reduction in the processing load of the second control unit 25. The second HBM 36B is a large-capacity memory device used to store the data.

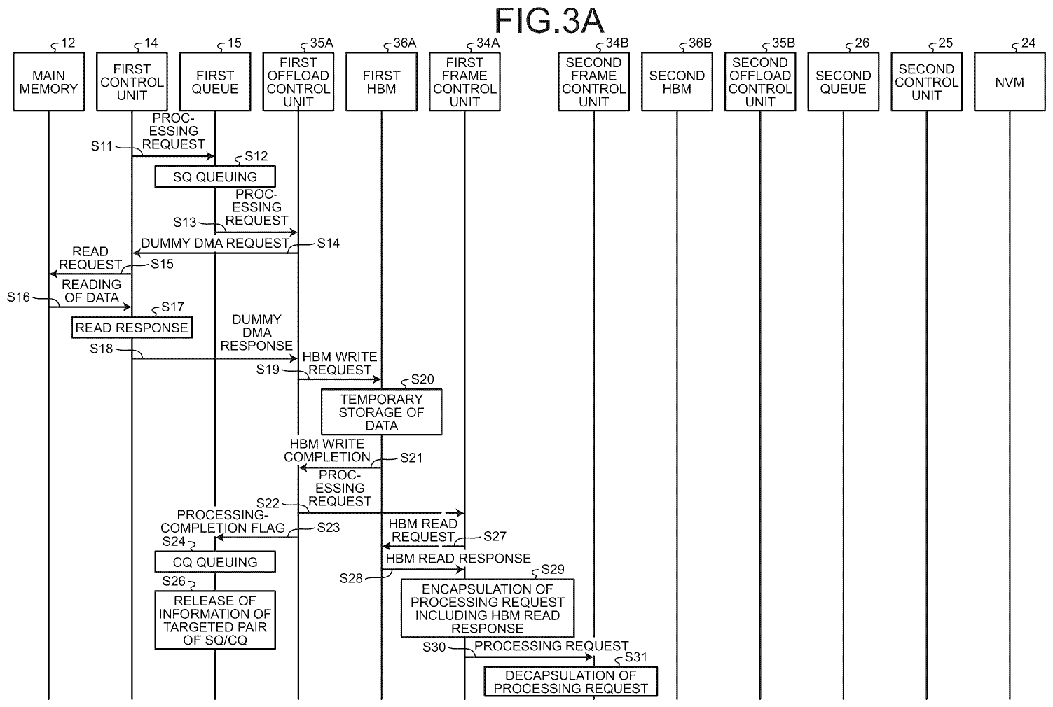

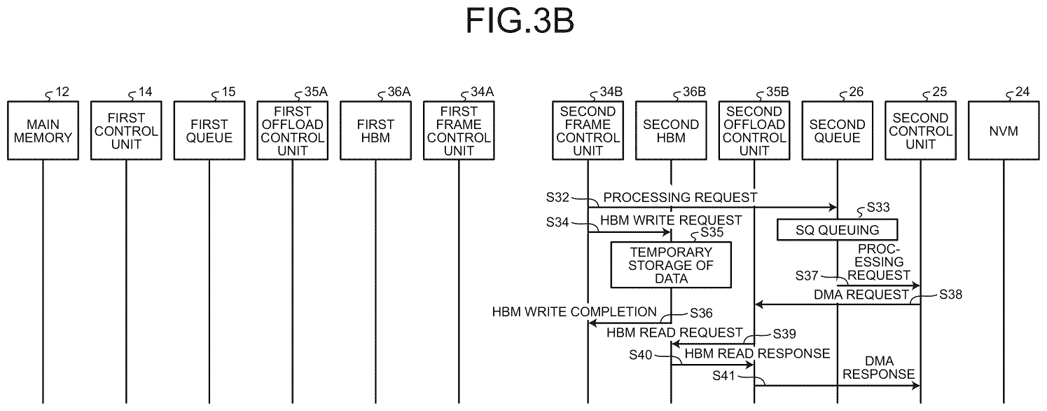

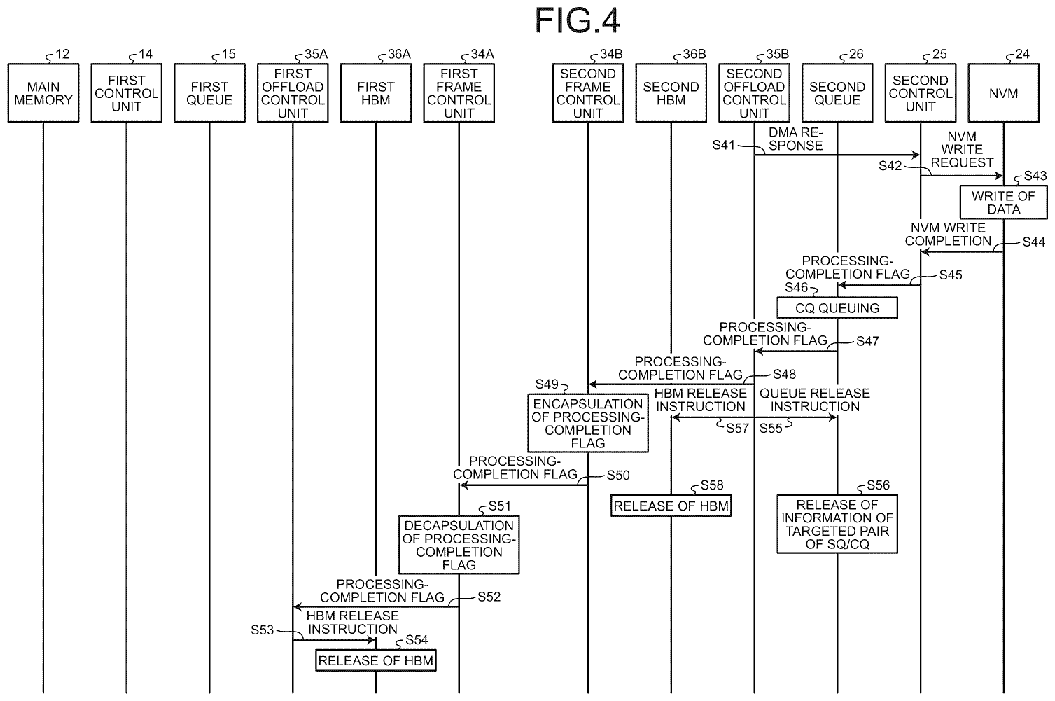

FIGS. 3A, 3B and 4 are sequence diagrams illustrating an example of the operations performed in the optical transmission system 1 in regard to the write-request processing. In the host CPU 11, the first control unit 14 issues an NVMe-of protocol processing request, such as a processing request for writing the target data for writing, which is stored in the main memory 12, into the NVM 24, and notifies the first queue 15 about the issued processing request (Step S11). Then, in the first queue 15, the notified processing request is subjected to SQ queuing in the first SQ 15A (Step S12).

In the first smart NIC 5A, the first offload control unit 35A detects a processing request, which is being queued in the first SQ 15A, according to the doorbell function of the first queue 15 (Step S13). Then, according to the detected processing request, the first offload control unit 35A issues a dummy DMA request to the first control unit 14 (Step S14). When detecting the dummy DMA request, the first control unit 14 issues a read request to the main memory 12 for reading the target data for writing from the main memory 12 according to the dummy DMA request (Step S15). According to the read request, the target data for writing is read from the main memory 12 (Step S16) and a read response, which includes the target data for writing that has been read, is sent to the first control unit 14 (Step S17).

When detecting the read response, the first control unit 14 sends a dummy DMA response, which includes the target data for writing that has been read, to the first offload control unit 35A (Step S18). When detecting the dummy DMA response, the first offload control unit 35A issues an HBM write request, which includes the target data for writing included in the dummy DMA response, to the first HBM 36A (Step S19). According to the HBM write request, the target data for writing that is specified in the HBM write request is temporarily stored in the first HBM 36A (Step S20), and the first offload control unit 35A is notified about HBM write completion (Step S21). Thus, the first offload control unit 35A reads the target data for writing from the main memory 12 according to a processing request, and temporarily stores the read data in the first HBM 36A.

Moreover, after detecting the HBM write completion, the first offload control unit 35A notifies the first frame control unit 34A about the processing request detected at Step S13 (Step S22). When detecting the processing request, the first frame control unit 34A issues an HBM read request to the first HBM 36A for reading the target data for writing that is stored in the first HBM 36A (Step S27). According to the HBM read request, an HBM read response, which includes the target data for writing that has been read, is sent from the first HBM 36A to the first frame control unit 34A (Step S28). Then, the first frame control unit 34A encapsulates a processing request that includes the HBM read response (Step S29). Subsequently, the first frame control unit 34A performs optical conversion of the encapsulated processing request using the first optical transceiver unit 31A, and optically transmits the post-optical-conversion processing request to the second smart NIC 5B via the optical transmission line 4 (Step S30). That is, the first offload control unit 35A reads the target data for writing that is temporarily stored in the first HBM 36A, and optically transmits the processing request, which includes the target data for writing that has been read, as the first handshake to the second smart NIC 5B.

After notifying the first frame control unit 34A about the processing request at Step S22, the first offload control unit 35A sends a processing-completion flag to the first queue 15 (Step S23). In the first queue 15, the notified processing-completion flag is subjected to CQ queuing in the first CQ 15B (Step S24). Then, the information about the targeted pair of SQ/CQ is released from the first queue 15 (Step S26). That is, before the processing request including the target data for writing is executed by the second smart NIC 5B, the first offload control unit 35A releases the queue of the first queue 15.

In the second frame control unit 34B, the second smart NIC 5B performs electrical conversion of the encapsulated processing request using the second optical transceiver unit 31B, decapsulates the post-electrical-conversion processing request, and breaks the decapsulated processing request down into the processing request and the target data for writing (Step S31). Then, the second frame control unit 34B sends the broken-down processing request to the second queue 26 of the controller 23 (Step S32). In the second queue 26, the processing request is subjected to SQ queuing in the second SQ 26A (Step S33). Moreover, the second frame control unit 34B issues an HBM write request to the second HBM 36B for writing the broken-down target data for writing in the second HBM 36B (Step S34).

In the second HBM 36B, the target data for writing, which is specified in the HBM write request, is temporarily stored according to the HBM write request (Step S35), and the second offload control unit 35B is notified about HBM write completion (Step S36).

The second control unit 25 detects the processing request, which is being queued in the second SQ 26A, according to the doorbell function of the second queue 26 (Step S37). According to the detected processing request, the second control unit 25 issues a DMA request to the second offload control unit 35B (Step S38). Then, according to the DMA request, the second offload control unit 35B issues an HBM read request to the second HBM 36B for reading the target data for writing from the second HBM 36B (Step S39). According to the HBM read request, the target data for writing is read from the second HBM 36B, and an HBM read response, which includes the target data for writing that has been read, is sent to the second offload control unit 35B (Step S40). When detecting the HBM read response, the second offload control unit 35B sends a DMA response, which includes the target data for writing that has been read, to the second control unit 25 as illustrated in FIG. 4 (Step S41). That is, according to the DMA request, the second control unit 25 becomes able to obtain the target data for writing from the second HBM 36B.

Then, according to the DMA request, the second control unit 25 issues an NVM write request to the NVM 24 for writing the target data for writing, which is included in the DMA response, in the NVM 24 (Step S42). According to the NVM write request, the target data for writing is written in the NVM 24 (Step S43) and, after the writing is completed, the second control unit 25 is notified about NVM write completion (Step S44). When detecting the NVM write completion, the second control unit 25 sends a processing-completion flag to the second queue 26 (Step S45). In the second queue 26, the processing-completion flag is subjected to CQ queuing in the second CQ 26B (Step S46).

The second offload control unit 35B detects the processing-completion flag in the second CQ 26B according to the doorbell function of the second queue 26 (Step S47). Then, the second offload control unit 35B sends the detected processing-completion flag to the second frame control unit 34B (Step S48). When detecting the processing-completion flag from the second offload control unit 35B, the second frame control unit 34B encapsulates the processing-completion flag (Step S49). Then, the second frame control unit 34B performs optical conversion of the encapsulated processing-completion flag using the second optical transceiver unit 31B, and optically transmits the post-optical-conversion processing-completion flag to the first smart NIC 5A via the optical transmission line 4 (Step S50). The processing-completion flag obtained at Step S50 represents the second handshake. However, at Step S26, since the information about the pair of SQ/CQ targeted in the first queue 15 is already released, there is no impact as far as the throughput is concerned from the perspective of the host CPU 11.

In the first smart NIC 5A, the first frame control unit 34A performs electrical conversion of the encapsulated processing-completion flag using the first optical transceiver unit 31A, and decapsulates the post-electrical-conversion processing-completion flag (Step S51). Moreover, the first frame control unit 34A sends the decapsulated processing-completion flag to the first offload control unit 35A (Step S52). According to the processing-completion flag, the first offload control unit 35A issues an HBM release instruction to the first HBM 36A (Step S53). According to the HBM release instruction, HBM releasing is performed in the first HBM 36A for deleting the target data for writing (Step S54). That marks the end of the operations explained with reference to FIG. 4. As a result, according to the HBM release instruction, the target data for writing can be deleted from the first HBM 36A.

Meanwhile, after sending the processing-completion flag to the second frame control unit 34B at Step S48, the second offload control unit 35B sends a queue release instruction to the second queue 26 (Step S55). Then, the information about the targeted pair of SQ/CQ is released from the second queue 26 (Step S56).

Moreover, after sending the processing-completion flag to the second frame control unit 34B at Step S48, the second offload control unit 35B sends an HBM release instruction to the second HBM 36B (Step S57). According to the HBM release instruction, HBM releasing is performed in the second HBM 36B for deleting the target data for writing (Step S58). That marks the end of the operations explained with reference to FIG. 4. Thus, according to the HBM release instruction, the target data for writing can be deleted from the second HBM 36B.

When detecting that the first control unit 14 has issued a processing request, the first smart NIC 5A reads, from the main memory 12, the target data for writing corresponding to the processing request and stores the data in the first HBM 36A. Then, the first smart NIC 5A optically transmits the processing request, which includes the target data for writing being stored in the first HBM 36A, as the first handshake to the storage server 3. Moreover, before the processing request is processed in the storage server 3, the first smart NIC 5A performs CQ queuing of the processing-completion flag of the processing request in the first CQ 15B and then releases first CQ 15B.

When detecting the processing request sent from the first smart NIC 5A, the second smart NIC 5B performs SQ queuing of the processing request in the second SQ 26A and stores the target data for writing in the second HBM 36B. According to the processing request queued in the second SQ 26A, the second control unit 25 stores the target data for writing, which is being stored in the second HBM 36B, in the NVM 24. Once the storage of the target data for writing in the NVM 24 is completed, the second control unit 25 performs CQ queuing of the processing-completion flag of the processing request in the second CQ 26B and then releases the second CQ 26B. Moreover, the second smart NIC 5B optically transmits the processing-completion flag as the second handshake to the computing server 2. Then, the first smart NIC 5A releases the first HBM 36A according to the processing-completion flag.

Thus, in the optical transmission system 1, from the time of SQ queuing till the release of the information about the pair of SQ/CQ, it suffices to perform only a single handshake of a processing request between the computing server 2 and the storage server 3 at Step S30. As a result, it becomes possible to shorten the transmission delay related to the processing requests per entry. That is, without having to increase the core count of the CPU, it becomes possible to implement the optical transmission system 1 of the NVMe-of type that is suitable for long-distance transmission and that is capable of achieving improvement in the processing delay including the transmission delay.

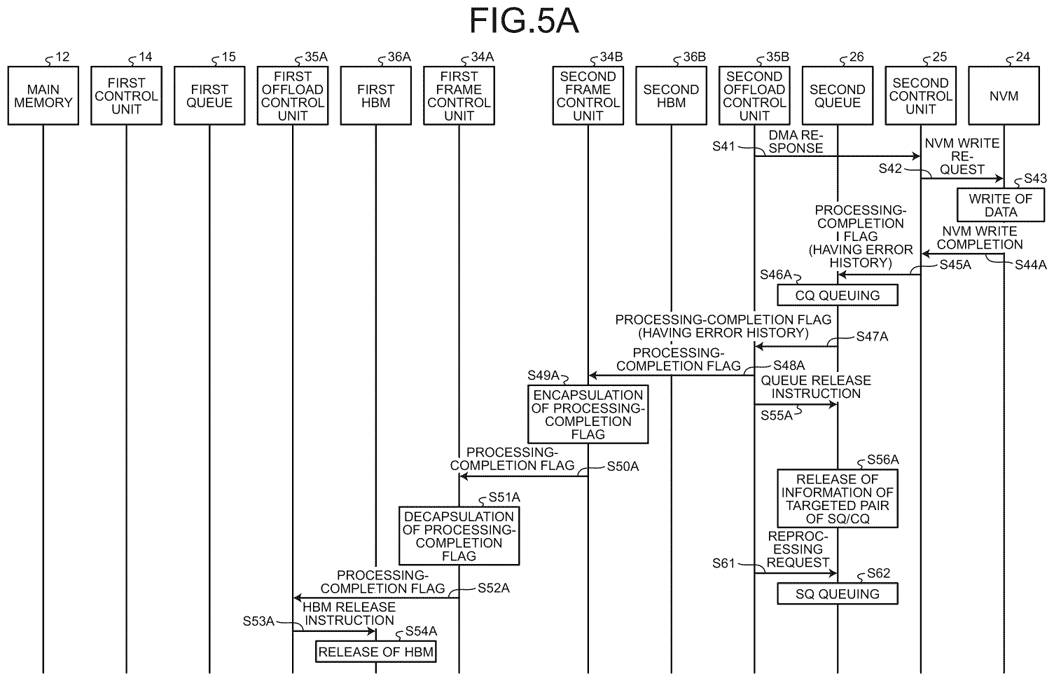

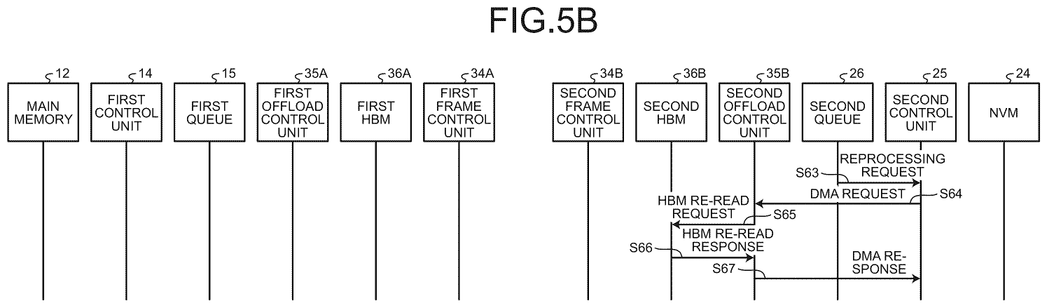

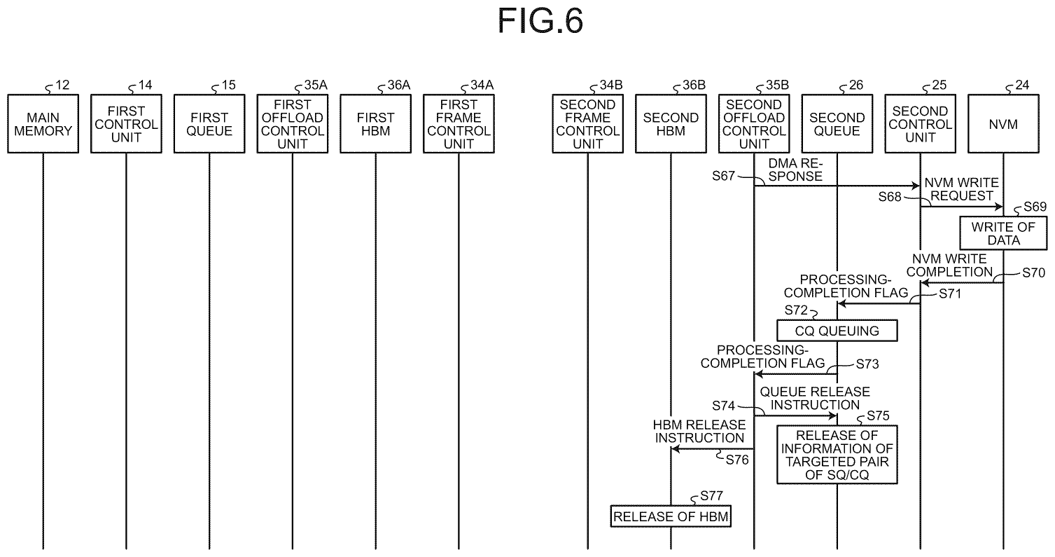

FIGS. 5A, 5B and 6 are sequence diagrams illustrating an example of the operations performed in the optical transmission system 1 in regard to a first-type data retransmission operation. The first-type data retransmission operation is performed when the second offload control unit 35B detects a processing-completion flag having an error history and when the target data for writing being stored in the second HBM 36B is normal.

After an NVM write request has been issued at Step S42, if NVM write completion having an error history is received from the NVM 24 (Step S44A), then the second control unit 25 notifies the second queue 26 about the processing-completion flag having an error history (Step S45A). In the second queue 26, the processing-completion flag having an error history is subjected to CQ queuing in the second CQ 26B (Step S46A).

The second offload control unit 35B detects the processing-completion flag having an error history from the second CQ 26B according to the doorbell function of the second queue 26 (Step S47A). When detecting the processing-completion flag having an error history and when determining the data stored in the second HBM 36B to be normal, the second offload control unit 35B sends a normal processing-completion flag to the second frame control unit 34B (Step S48A). Herein, the normal processing-completion flag is a processing-completion flag which does not have any error history and which indicates that the execution of the processing request is completed.

When detecting a processing-completion flag from the second offload control unit 35B, the second frame control unit 34B encapsulates the processing-completion flag (Step S49A). Then, the second frame control unit 34B performs optical conversion of the encapsulated processing-completion flag using the second optical transceiver unit 31B, and optically transmits the post-optical-conversion processing-completion flag to the first smart NIC 5A via the optical transmission line 4 (Step S50A).

In the first smart NIC 5A, the first frame control unit 34A performs electrical conversion of the encapsulated processing-completion flag using the first optical transceiver unit 31A, and decapsulates the post-electrical-conversion processing-completion flag (Step S51A). Moreover, the first frame control unit 34A sends the decapsulated processing-completion flag to the first offload control unit 35A (Step S52A). According to the processing-completion flag, the first offload control unit 35A issues an HBM release instruction to the first HBM 36A (Step S53A). Then, according to the HBM release instruction, HBM releasing is performed in the first HBM 36A for deleting the target data for writing (Step S54A). As a result, the first smart NIC 5A enables deletion of the target data for writing from the first HBM 36A.

Meanwhile, after sending the processing-completion flag to the second frame control unit 34B at Step S48A, the second offload control unit 35B sends a queue release instruction to the second queue 26 (Step S55A). Then, the information about the targeted pair of SQ/CQ is released from the second CQ 26B of the second queue 26 (Step S56A).

After the queue release instruction is sent to the second queue 26 at Step S55A, the second offload control unit 35B sends a reprocessing request to the second queue 26 (Step S61). The reprocessing request is a processing request for again reading the target data for writing, which is being stored in the second HBM 36B, from the second HBM 36B and writing the target data for writing, which has been read, in the NVM 24.

In the second queue 26, the reprocessing request is subjected to SQ queuing in the second SQ 26A (Step S62). Then, the second control unit 25 detects the reprocessing request, which is stored in the second SQ 26A, according to the doorbell function of the second queue 26 (Step S63). According to the detected reprocessing request, the second control unit 25 issues a DMA request to the second offload control unit 35B (Step S64).

According to the DMA request, the second offload control unit 35B issues an HBM re-read request to the second HBM 36B for again reading the target data for writing from the second HBM 36B (Step S65). According to the HBM re-read request, the target data for writing is again read from the second HBM 36B and an HBM re-read response, which includes the target data for writing that has been read, is sent to the second offload control unit 35B (Step S66). When detecting the HBM re-read response, the second offload control unit 35B sends a DMA response, which includes the target data for writing included in the HBM re-read response, to the second control unit 25 (Step S67).

With reference to FIG. 6, according to the DMA request, the second control unit 25 issues an NVM write request to the NVM 24 for writing the target data for writing, which is specified in the DMA response, in the NVM 24 (Step S68). In the NVM 24, the target data for writing is written according to the NVM write request (Step S69) and, after the writing is completed, the second control unit 25 is notified about NVM write completion (Step S70).

When detecting the NVM write completion, the second control unit 25 sends a processing-completion flag regarding the reprocessing request to the second queue 26 (Step S71). In the second queue 26, the processing-completion flag is subjected to CQ queuing in the second CQ 26B (Step S72).

Moreover, the second offload control unit 35B detects the processing-completion flag in the second CQ 26B according to the doorbell function of the second queue 26 (Step S73). According to the detected processing-completion flag, the second offload control unit 35B sends a queue release instruction to the second queue 26 (Step S74). Then, the information about the targeted pair of SQ/CQ is released from the second CQ 26B (Step S75).

After the queue release instruction is sent to the second queue 26 at Step S74, the second offload control unit 35B sends an HBM release instruction to the second HBM 36B (Step S76). According to the HBM release instruction, HBM releasing is performed in the second HBM 36B for deleting the target data for writing (Step S77). That marks the end of the operations explained with reference to FIG. 6.

When detecting a processing-completion flag having an error history, the second control unit 25 again reads the target data for writing from the second HBM 36B and writes that data in the NVM 24. As a result, the target data for writing that was lost due to an error can be obtained again and can be written in the NVM 24.

In the present embodiment, when detecting the processing request that the computing server 2 issued to the storage server 3, the first smart NIC 5A performs SQ queuing of the processing request in the first queue 15. Then, the first smart NIC 5A obtains the data according to the processing request from the main memory 12 and stores the obtained data in the first HBM 36A. The first smart NIC 5A requests the storage server 3 for transferring the data and the processing request, performs CQ queuing of the processing completion in the first queue 15, and releases the queue of that processing completion. As a result, it becomes possible to lower the number of handshakes related to the processing requests between the computing server 2 and the storage server 3. Hence, the transmission delay can be held down and the throughput can be improved.

When receiving the processing request and the data transferred from the first smart NIC 5A, the second smart NIC 5B stores the received data in the second HBM 36B. Moreover, the second smart NIC 5B performs SQ queuing of the received processing request in the second queue 26 and, according to the processing request queued in the second queue 26, performs a writing operation for writing the data, which is being stored in the second HBM 36B, in the NVM 24. After performing the writing operation, the second smart NIC 5B performs CQ queuing of the processing completion of that processing request in the second queue 26, and releases the queue of that processing completion. As a result, it becomes possible to lower the number of handshakes related to the processing requests between the computing server 2 and the storage server 3. Hence, the transmission delay can be held down and the throughput can be improved.

In the optical transmission system 1, from the time of SQ queuing till the release of the information about the pair of SQ/CQ, it suffices to perform only a single handshake regarding the processing request between the first smart NIC 5A and the second smart NIC 5B at Step S30. Hence, as compared to the comparison example, the handshake processing can be reduced by an amount equivalent to four handshakes. As a result, in the optical transmission system 1, it becomes possible to reduce the number of handshakes related to DMA requests, DMA responses, and queue release instructions explained in the comparison example. That enables holding down the transmission delay and significantly shortening the processing delay related to the processing requests.

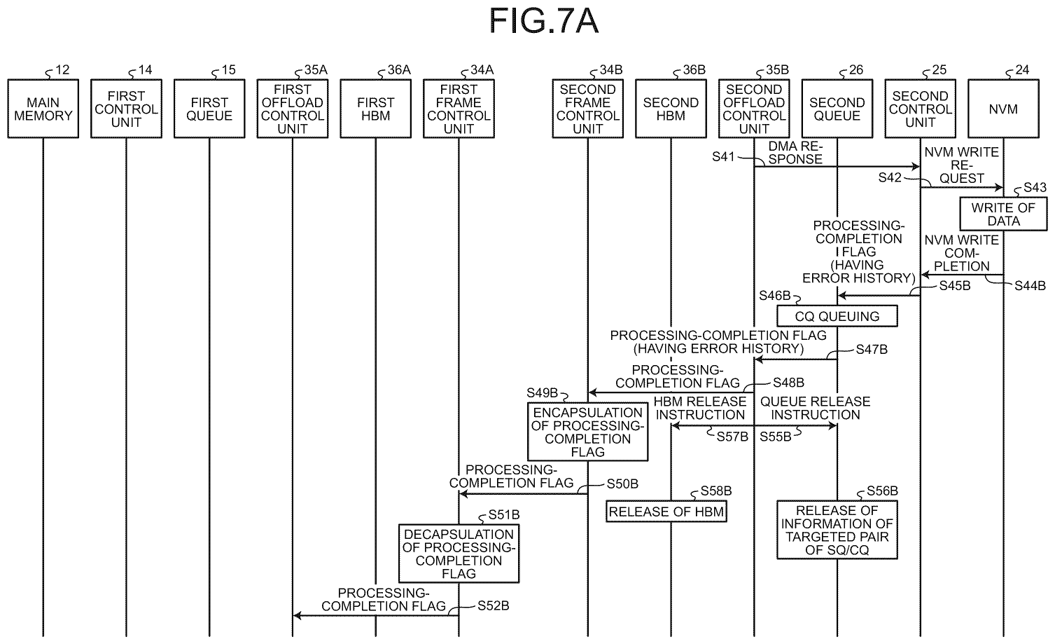

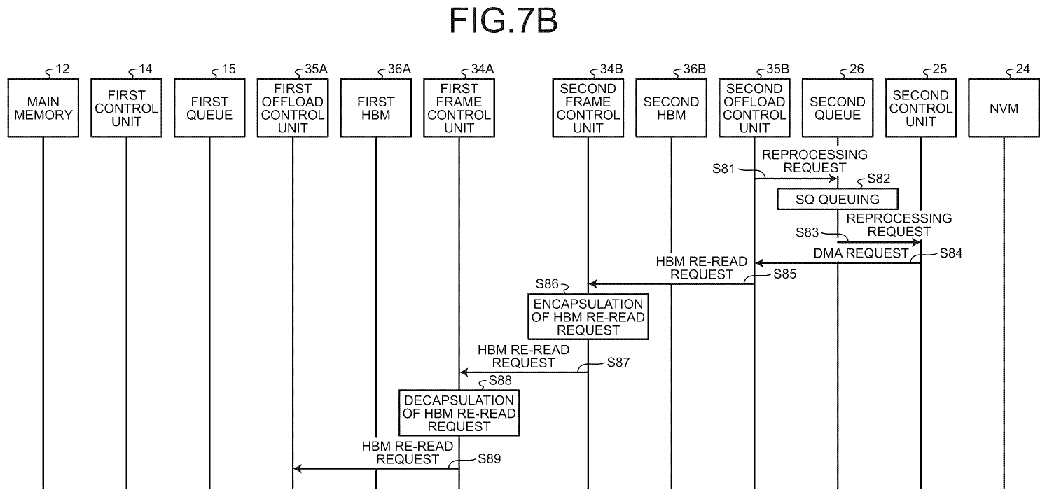

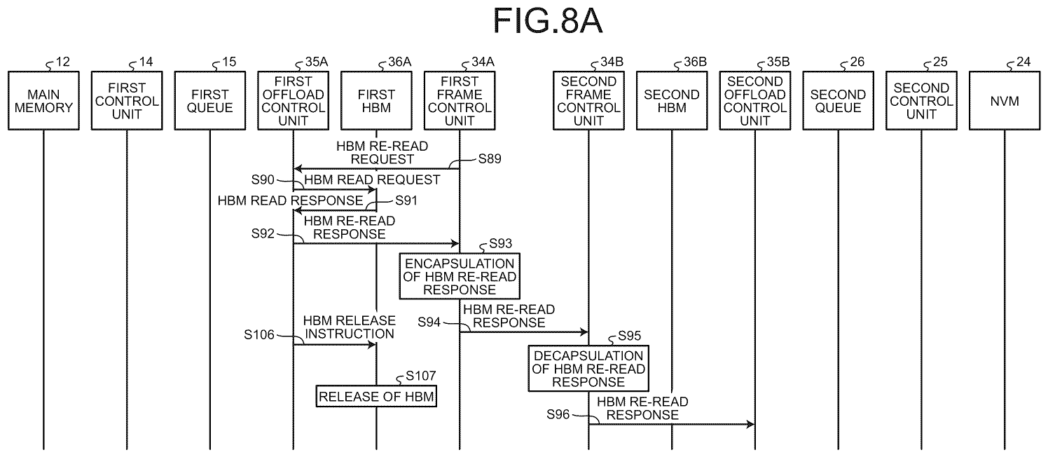

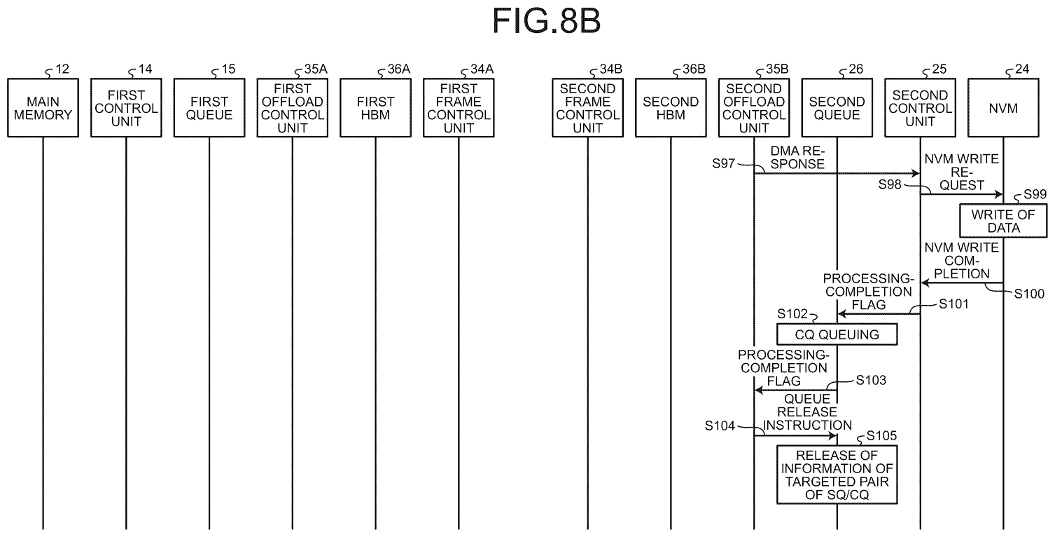

In the first-type data retransmission processing, when the second control unit 25 detects an error indicating the loss of the target data for writing, the target data for writing is again read from the second HBM 36B and is written in the NVM 24. However, if the data being stored in the second HBM 36B also encounters an error, then the target data for writing being stored in the first HBM 36A needs to be obtained again. In that regard, explained with reference to FIGS. 7A, 7B, 8A and 8B is a second-type data retransmission operation.

FIGS. 7A, 7B, 8A and 8B are sequence diagrams illustrating an example of the operations performed in the optical transmission system 1 in regard to the second-type data retransmission operation. The second-type data retransmission operation is performed when the second offload control unit 35B detects a processing-completion flag having an error history and when the target data for writing being stored in the first HBM 36A is normal.

After issuing an NVM write request at Step S42, when detecting NVM write completion having an error history (Step S44B), the second control unit 25 sends a processing-completion flag having an error history to the second queue 26 (Step S45B). In the second queue 26, the processing-completion flag having an error history is subjected to CQ queuing in the second CQ 26B (Step S46B).

The second offload control unit 35B detects the processing-completion flag having an error history from the second CQ 26B according to the doorbell function of the second queue 26 (Step S47B). When detecting the processing-completion flag having an error history and when determining the data stored in the second HBM 36B to be normal, the second offload control unit 35B sends a normal processing-completion flag to the second frame control unit 34B (Step S48B). At that time, since it is known that re-reading from the first HBM 36A would be performed later, a flag is added for disabling the release instruction regarding the first HBM 36A.

When detecting the processing-completion flag from the second offload control unit 35B, the second frame control unit 34B encapsulates the processing-completion flag (Step S49B). Then, the second frame control unit 34B performs optical conversion of the encapsulated processing-completion flag using the second optical transceiver unit 31B, and optically transmits the post-optical-conversion processing-completion flag to the first smart NIC 5A via the optical transmission line 4 (Step S50B).

In the first smart NIC 5A, the first frame control unit 34A performs electrical conversion of the encapsulated processing-completion flag using the first optical transceiver unit 31A, and decapsulates the post-electrical-conversion processing-completion flag (Step S51B). Moreover, the first frame control unit 34A sends the decapsulated processing-completion flag to the first offload control unit 35A (Step S52B).

Meanwhile, after sending the processing-completion flag to the second frame control unit 34B at Step S48B, the second offload control unit 35B sends a queue release instruction to the second queue 26 (Step S55B). Then, the information about the targeted pair of SQ/CQ is released from the second CQ 26B of the second queue 26 (Step S56B).

Moreover, after sending the processing-completion flag to the second frame control unit 34B at Step S48B, the second offload control unit 35B sends an HBM release instruction the second HBM 36B (Step S57B). According to the HBM release instruction, HBM releasing is performed in the second HBM 36B for deleting the target data for writing (Step S58B). Thus, the second smart NIC 5B enables deletion of the target data for writing from the second HBM 36B.

After sending the queue release instruction to the second queue 26 at Step S55B, the second offload control unit 35B issues a reprocessing request to the second queue 26 (Step S81). The reprocessing request is a processing request for again reading the target data for writing, which is being stored in the first HBM 36A, from the first HBM 36A and writing the target data for writing, which has been read, in the NVM 24.

In the second queue 26, the reprocessing request is subjected to SQ queuing in the second SQ 26A (Step S82). Then, the second control unit 25 detects the reprocessing request, which is stored in the second SQ 26A, according to the doorbell function of the second queue 26 (Step S83). According to the detected reprocessing request, the second control unit 25 issues a DMA request to the second offload control unit 35B (Step S84).

According to the DMA request, the second offload control unit 35B issues an HBM re-read request to the second frame control unit 34B for again reading the target data for writing from the first HBM 36A (Step S85). When detecting the HBM re-read request issued from the second offload control unit 35B, the second frame control unit 34B encapsulates the HBM re-read request (Step S86). Then, the second frame control unit 34B performs optical conversion of the encapsulated HBM re-read request using the second optical transceiver unit 31B, and optically transmits the post-optical-conversion HBM re-read request to the first smart NIC 5A via the optical transmission line 4 (Step S87).

In the first smart NIC 5A, the first frame control unit 34A performs electrical conversion of the HBM re-read request using the first optical transceiver unit 31A, and decapsulates the post-electrical-conversion HBM re-read request (Step S88). Moreover, the first frame control unit 34A sends the decapsulated HBM re-read request to the first offload control unit 35A (Step S89).

According to the HBM re-read request, the first offload control unit 35A issues an HBM read request to the first HBM 36A (Step S90). Then, according to the HBM read request, the target data for writing is again read from the first HBM 36A and an HBM read response, which includes the target data for writing that has been read, is sent to the first offload control unit 35A (Step S91). When detecting the HBM read response, the first offload control unit 35A sends an HBM re-read response, which includes the target data for writing that has been read, to the first frame control unit 34A (Step S92). Moreover, after sending the HBM re-read response, the first offload control unit 35A sends an HBM release instruction to the first HBM 36A (Step S106). According to the HBM release instruction, HBM releasing is performed in the first HBM 36A for deleting the target data for writing (Step S107).

When detecting the HBM re-read response from the second offload control unit 35A, the first frame control unit 34A encapsulates the HBM re-read response (Step S93). Then, the second frame control unit 34B performs optical conversion of the encapsulated HBM re-read response using the second optical transceiver unit 31B, and optically transmits the post-optical-conversion HBM re-read response to the second smart NIC 5B via the optical transmission line 4 (Step S94).

In the second smart NIC 5B, the second frame control unit 34B performs electrical conversion of the HBM re-read response using the first optical transceiver unit 31A and decapsulates the post-electrical-conversion HBM re-read response (Step S95). Moreover, the second frame control unit 34B sends the decapsulated HBM re-read response to the second offload control unit 35B (Step S96). Then, according to the HBM re-read response, the second offload control unit 35B sends a DMA response to the second control unit 25 (Step S97).

According to the DMA response, the second control unit 25 issues an NVM write request to the NVM 24 for writing the target data for writing, which is included in the DMA response, in the NVM 24 (Step S98). According to the NVM write request, the target data for writing is written in the NVM 24 (Step S99) and, after the writing is completed, the second control unit 25 is notified about NVM write completion (Step S100).

When detecting the NVM write completion, the second control unit 25 sends a processing-completion flag regarding the reprocessing request to the second queue 26 (Step S101). In the second queue 26, the processing-completion flag is subjected to CQ queuing in the second CQ 26B (Step S102).

Moreover, the second offload control unit 35B detects the processing-completion flag in the second CQ 26B according to the doorbell function of the second queue 26 (Step S103). According to the detected processing-completion flag, the second offload control unit 35B sends a queue release instruction to the second queue 26 (Step S104). Then, the information about the targeted pair of SQ/CQ is released from the second queue 26 (Step S105). That marks the end of the operations explained with reference to FIGS. 8A and 8B.

When detecting a processing-completion flag having an error history, the second control unit 25 again obtains the target data for writing from the first HBM 36A and writes the obtained data in the NVM 24. As a result, the target data for writing that was lost due to an error can be obtained again and can be written in the NVM 24.

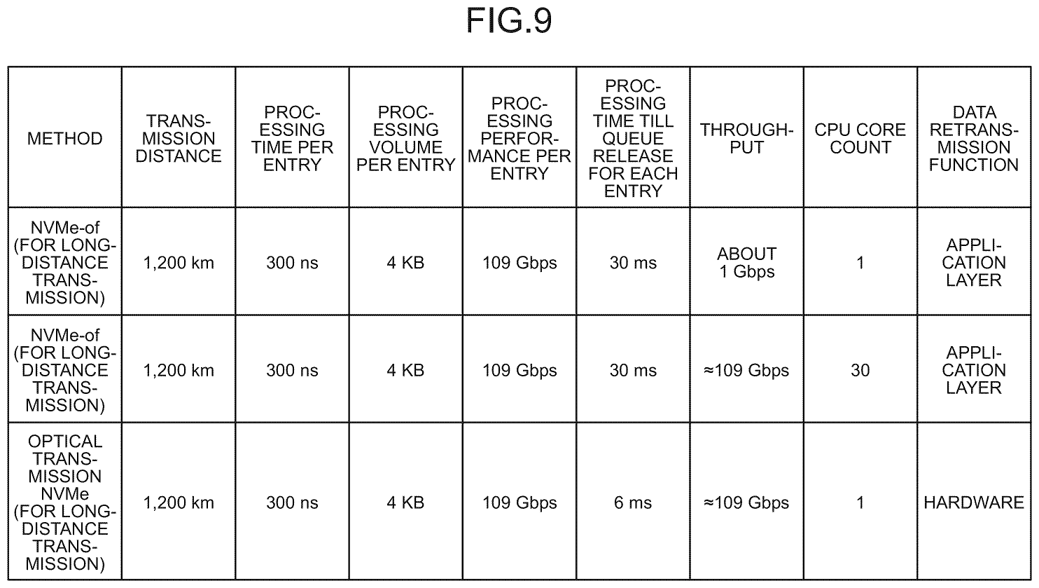

FIG. 9 is an explanatory diagram for explaining an example of the comparison result of comparison between the optical transmission system 1 according to the present working example and the optical transmission system 100 according to the comparison example. In the optical transmission system 100 of the NVMe-of type according to the comparison example in which a single-core CPU is used for long-distance optical transmission, the transmission distance between the computing server 110 and the storage server 120 is set to 1200 km, and the processing time per entry is set to 300 ns. Moreover, in the optical transmission system 100, the processing volume per entry is set to 4 KB, the processing performance per entry is set to 109 Gbps, the processing time till the queue release for each entry is set to 30 μs, and the core count of the CPU is set to one. In that case, the optical transmission system 100 according to the comparison example has the throughput of about 1 Gbps. Meanwhile, the data retransmission function is implemented in the application layer.

In an optical transmission system of the NVMe-of type in which a multicore CPU is used for long-distance transmission, the transmission distance between the computing server 110 and the storage server 120 is set to 1200 km, and the processing time per entry is set to 300 ns. Moreover, in the optical transmission system, the processing volume per entry is set to 4 KB, the processing performance per entry is set to 109 Gbps, the processing time till the queue release for each entry is set to 30 μs, and the core count of the CPU is set to 30. In that case, the throughput is about 109 Gbps. Meanwhile, the data retransmission function is implemented in the application layer.

In contrast, in the optical transmission system 1 of the NVM-of type according to the present working example in which a single-core CPU is used for long-distance transmission, the transmission distance between the computing server 2 and the storage server 3 is set to 1200 km, and the processing time per entry is set to 300 ns. Moreover, in the optical transmission system 1, the processing volume per entry is set to 4 KB, the processing performance per entry is set to 109 Gbps, the processing time per entry till queue releasing is set to 6 ms, and the core count of the CPU is set to one. In that case, the optical transmission system 1 according to the present embodiment has the throughput of about 109 Gbps. Meanwhile, the data retransmission function is implemented using hardware.

Thus, as compared to the optical transmission system 100 according to the comparison example, it can be understood that there is a significant improvement in the throughput in the optical transmission system 1 according to the embodiment. Moreover, even in comparison to an optical transmission system in which a multicore CPU is used, the improvement in the throughput can be achieved while holding down the component cost.

Meanwhile, for explanatory convenience, the first smart NIC 5A can be embedded in the computing server 2, and the second smart NIC 5B can be embedded in the storage server 3. Thus, such configuration can be appropriately modified.

As far as a processing request is concerned, the explanation is given about a processing request issued for writing the target data for writing, which is stored in the main memory 12, in the NVM 24. However, that is not the only possible case, and the processing request can be appropriately varied.

Moreover, the explanation is given about the case in which optical transmission between the computing server 2 and the storage server 3 is performed using the optical transmission line 4. However, the transmission is not limited to the use of the optical transmission line 4. Alternatively, a transmission line that transmits electrical signals can be used. Thus, the transmission mode can be appropriately varied.

Furthermore, the explanation is given about the case in which encapsulation and decapsulation is performed at the time of transmitting signals between the first smart NIC 5A and the second smart NIC 5B. However, that is not the only possible case. Alternatively, the signals can be transmitted without performing encapsulation and decapsulation. Thus, the manner of transmission can be appropriately varied.

Moreover, the explanation is given about the case in which the NVMe-of protocol is used at the time of transmitting signals between the first smart NIC 5A and the second smart NIC 5B. Alternatively, for example, as long as a communication protocol capable of managing the processing requests in a queue is used, the communication protocol can be appropriately varied.

The constituent elements of the device illustrated in the drawings need not be physically configured as illustrated. The constituent elements, as a whole or in part, can be separated or integrated either functionally or physically based on various types of loads or use conditions.

The process functions implemented in the device can be entirely or partially implemented by a CPU (Central Processing Unit) (or by a microcomputer such as an MPU (Micro Processing Unit) or an MCU (Micro Controller Unit)). Alternatively, it goes without saying that the processing functions can be entirely or partially implemented by computer programs that are analyzed and executed by a CPU (or a microcomputer such as an MPU or an MCU), or can be implemented as hardware using wired logic.

According to an aspect, a transmission device is provided that is suitable for long-distance transmission between a server and an opposing device.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A transmission device that transmits a signal between a server and an opposing device, the transmission device comprising:
a memory; and
a controller that controls a first queue in the server and a second queue in the server, and controls the memory, wherein
when detecting issuance of a processing request from the server to the opposing device, the controller queues the processing request in the first queue, obtains data from the server according to the processing request, and stores the obtained data in the memory, and
after requesting transfer of the data and the processing request to the opposing device, before executing the processing request in the opposing device, the controller queues processing completion of the processing request in the second queue and releases queue of the processing completion.

2. The transmission device according to claim 1, wherein, according to processing completion received from the opposing device, the controller deletes data being stored in the memory.

3. A transmission device that transmits a signal between a server and an opposing device, the transmission device comprising:
a memory; and
a controller that controls a first queue in the opposing device and a second queue in the opposing device, and controls the memory, wherein
when receiving a processing request and data transferred from the server, the controller stores the received data in the memory,
the controller queues the received processing request in the first queue and, according to the processing request queued in the first queue, executes the processing request using data stored in the memory, and
after executing the processing request, the controller queues processing completion of the processing request in the second queue and releases queue of the processing completion.

4. The transmission device according to claim 3, wherein
when detecting an error in the data related to the processing request, the controller issues a reprocessing request and queues the reprocessing request in the first queue,
according to the reprocessing request queued in the first queue, the controller reads concerned data from the memory and executes the processing request using the read data, and
after executing the processing request, the controller queues processing completion of the processing request in the second queue and releases queue of the processing completion.

5. The transmission device according to claim 3, wherein
when detecting an error in the data related to the processing request, the controller issues a reprocessing request and queues the reprocessing request in the first queue,
according to the reprocessing request queued in the first queue, the controller receives data being stored in a transmission device at a side of the server and executes the processing request using the received data, and
after executing the processing request, the controller queues processing completion of the processing request in the second queue and releases queue of the processing completion.

6. A transmission system that transmits a signal between a first transmission device, which is connected to a server, and a second transmission device, which is connected to an opposing device, wherein
the first transmission device includes
a first memory, and
a first controller that controls a first queue in the server and a second queue in the server, and controls the first memory,
when detecting issuance of a processing request from the server to the opposing device, the first controller queues the processing request in the first queue in the server, obtains data from the server according to the processing request, and stores the obtained data in the first memory, and
after requesting transfer of the data and the processing request to the second transmission device, before executing the processing request in the second transmission device, the first controller queues processing completion of the processing request in the second queue in the server and releases queue of the processing completion.

7. The transmission system according to claim 6, wherein
the second transmission device includes
a second memory, and
a second controller that controls a first queue in the second transmission device and a second queue in the second transmission device, and controls the second memory,
when receiving a processing request and data transferred from the first transmission device, the second controller stores the received data in the second memory,
the second controller queues the received processing request in the first queue in the second transmission device and, according to the processing request queued in the first queue in the second transmission device, executes the processing request using data stored in the second memory, and
after executing the processing request, queues processing completion of the processing request in the second queue in the second transmission device and releases queue of the processing completion.
